(19) United States
(12) Patent Application Publication
(10) Pub. No.: US 2013/0188172 A1
(43) Pub. Date: Jul. 25, 2013

(54) MICROFLUIDIC CHIP ASSEMBLY

(71) Applicants: Kai-Mei Camilla Fu, Palo Alto, CA (US); Paul Edward Barclay, Palo Alto, CA (US); David A. Fattal, Mountain View, CA (US); Jingjing Li, Palo Alto, CA (US); Raymond G. Beausoleil, Redmond, WA (US)

(72) Inventors: Kai-Mei Camilla Fu, Palo Alto, CA (US); Paul Edward Barclay, Palo Alto, CA (US); David A. Fattal, Mountain View, CA (US); Jingjing Li, Palo Alto, CA (US); Raymond G. Beausoleil, Redmond, WA (US)

(21) Appl. No.: 13/877,319

(22) PCT Filed: Oct. 11, 2010
(86) PCT No.: PCT/US2010/052179

§ 371 Date: Apr. 1, 2013

(51) Int. Cl. G01N 21/03

(52) U.S. Cl. CPC G01N 21/0303
USPC 356/51; 356/246

(57) ABSTRACT

In one embodiment, an optical system includes a microfluidic chip assembly. The microfluidic chip assembly includes a first structure that provides a first wall of a fluid channel. A second structure provides a second wall of the fluid channel. The second structure includes a diffraction grating configured to provide, in the presence of incident light of a wavelength band of interest on a first surface of the second structure, a plurality of regions of high intensity light within the fluid channel.

### BACKGROUND

Optical traps are optical systems used to manipulate small (e.g., nanometer and micrometer-sized particles) by exerting small forces via a highly focused laser beam. The narrowest point of the focused beam, known as the beam waist, contains a very strong electric field gradient. Dielectric particles are attracted along the gradient to the region of strongest electric field, which is the center of the beam, effectively trapping the particle within the beam. The trapped particle can then be imaged or held in place while other particles are flushed, allowing for sorting of the captured particle from other particles in a fluid medium. Alternatively, optical trapping can be used for tracking of movement (e.g., of bacteria), application and measurement of small forces, and altering larger structures, such as cell membranes.

### BRIEF DESCRIPTION OF THE DRAWINGS

FIG. 1 illustrates a cross-sectional view of an example of a microfluidic chip assembly.

FIG. 2 illustrates a cross-sectional view of an example of an optical system to provide a plurality of selectable optical trap regions within a microfluidic chip assembly.

FIG. 3 illustrates an example of an optical system to provide a plurality of optical trap regions within a microfluidic chip assembly.

FIG. 4 illustrates a flow chart of an example methodology for conveying a particle to a desired location within a microfluidic chip.

### DETAILED DESCRIPTION

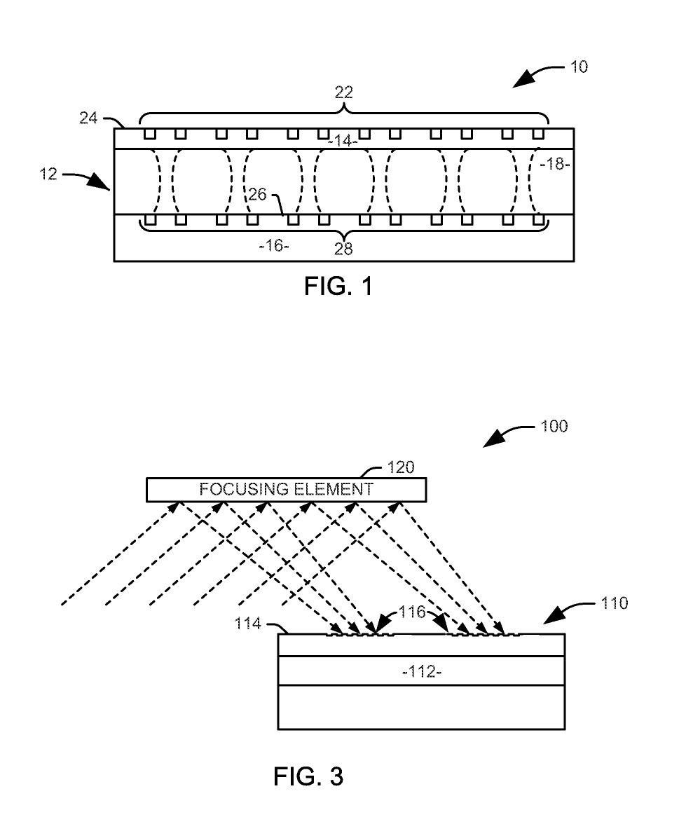

FIG. 1 illustrates a cross-sectional view of an example of a microfluidic chip assembly 10. The microfluidic chip assembly 10 includes a fluid channel 12, to carry a fluid medium, and respective first and second structures 14 and 16 that form opposing walls of the fluid channel. It will be appreciated that the fluid channel 12 can further comprise at least a first side wall 18 and a second side wall (not shown) that support one of the first and second structures 16 and 18. In one example, the first and second structures 14 and 16 and the side walls 18 are fabricated from a wafer of an appropriate material via micromachining techniques. The first structure 14 includes a diffraction grating 22 to provide an interference pattern within fluid channel 12, as to provide a plurality of regions of high intensity light when light is incident on a first surface 24 of the first structure. It will be appreciated, however, that the terms “a” and “an” are used inclusively throughout this application, such that they may reference one or more than one element. The diffraction grating 22 can be implemented as a guided mode resonance grating, such that the interference pattern is produced only when light of in the wavelength band of interest is incident on the first surface 24.

The first structure 14 can be made from any appropriate material that is transparent across the wavelength band of interest and has an index of refraction significantly larger than the fluid medium for the wavelength band of interest. For example, where the wavelength band of interest is in the near infrared range, the first structure 14 can be fabricated from silicon. When the wavelength band of interest is in the visible spectrum, the first structure 14 can be fabricated from gallium phosphide, silicon carbide, or silicon nitride.

The second structure 16 is configured to allow for confinement of the incident light within the fluid channel 12. In one example, the second structure 16 can comprise a first surface 26 that is flat and highly reflective across the wavelength band of interest. In another example, the second structure 16 can include a diffraction grating 28 similar to the diffraction grating 22 on the first structure 14. The second structure 16 can be fabricated from any material that is reflective across the wavelength band of interest. In one implementation, the first surface 14 and the second surface 16 can be fabricated from a single wafer via a bulk micromachining process.

In the illustrated example, the microfluidic chip assembly 10 can be used in an optical trapping application, in which the position and trajectory of particles within the fluid medium can be manipulated via a series of optical traps. To this end, the diffraction grating 22 can be configured to provide traps in any desired configuration. For example, the diffraction grating 22 can be configured such that the series of traps includes a line trap that guides particles along the fluid channel 12 and a point trap configured to hold a particle in place for imaging or other analysis. By using the diffraction grating 22 to provide the high intensity regions, a low cost, planar implementation of an optical trapping assembly is provided, while permitting significant versatility in the interference patterns produced in the fluid channel 12.

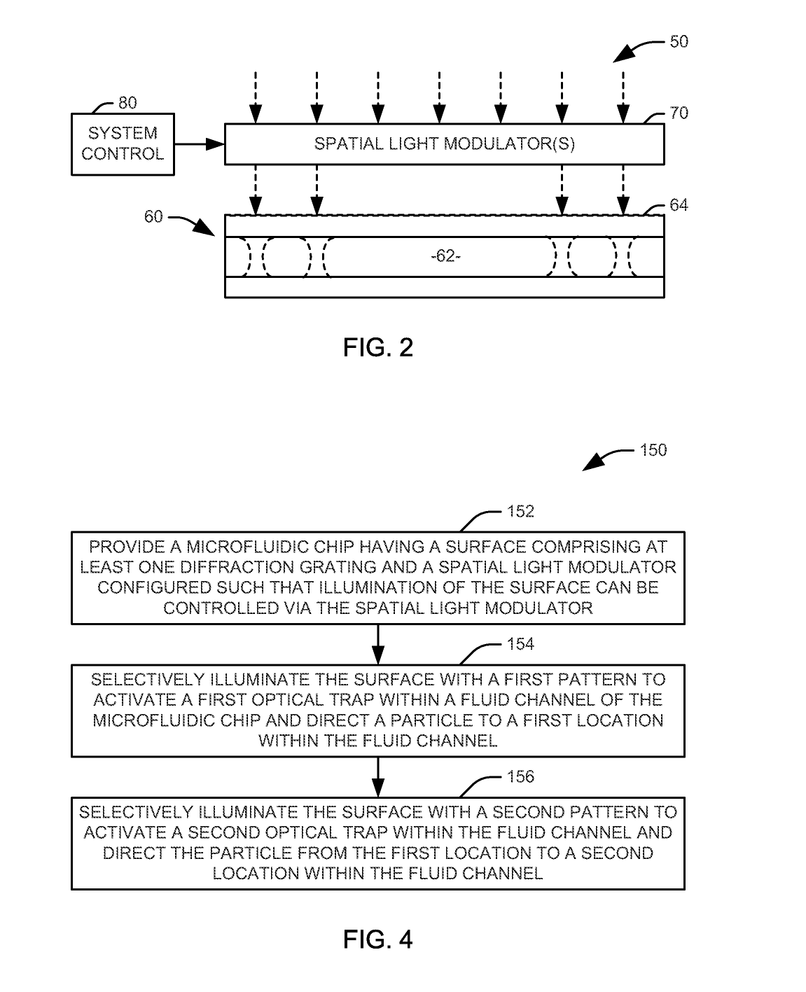

FIG. 2 illustrates a cross-sectional view of an example of an optical system 50 to provide a plurality of selectable optical trap regions within a microfluidic chip assembly 60. The microfluidic chip assembly 60 comprises a fluid channel 62 and a first surface 64 incorporating a diffraction grating. The diffraction grating is configured such that, when light of a wavelength band of interest is incident upon the first surface 64, a plurality of regions of high intensity light are produced within the fluid channel 62. The diffraction pattern and the wavelength band of interest can be selected such that the regions of high intensity light allow for optical trapping of particles within the fluid channel 62.

The system 50 includes a spatial light modulator 70 configured to selectively permit incident light to pass through to the microfluidic chip assembly 60. For example, the spatial light modulator(s) 70 can be bonded to a surface of the microfluidic chip assembly 60 or placed into close proximity to the chip assembly. The spatial light modulator(s) 70 can comprise an electrically addressed spatial light modulator configured to selectively modify one of the phase and the amplitude of incident light. In the illustrated example, the spatial light modulator 70 is configured to be electrically addressable via a system control 80 to selectively attenuate light passing through the spatial light modulator.

During operation, at least a portion of the microfluidic chip assembly 60 can be illuminated, for example, with a monochromatic light source such as a laser, to provide an optical trap within the fluid channel 62. Once a particle is caught in an optical trap, a new attenuation pattern can be provided by the spatial light modulator(s) 70 to temporarily block light to a region of the microfluidic chip assembly 60 associated with the optical trap containing the particle to release the particle. The new attenuation pattern can be configured to provide light to other portions of the microfluidic chip assembly 60 as to activate additional optical traps as to further influence the position or trajectory of the release particle. By manipulating the attenuation pattern of the spatial light modulator(s) 70, and thus the activation and deactivation of optical traps within the fluid channel 62, the system control 80 can provide a desired trajectory to a given particle within the fluid channel.

FIG. 3 illustrates an example of an optical system 100 to provide a plurality of optical trap regions within a microfluidic chip assembly 110. The microfluidic chip assembly 110 comprises a fluid channel 112 and a first surface 114 incorporating a diffraction grating 116. The diffraction grating is configured such that, when light of a wavelength band of interest is incident upon the first surface 114, a plurality of regions of high intensity light are produced within the fluid channel 112. A pattern associated with the diffraction grating 116 can be selected such that the regions of high intensity light allow for optical trapping of particles within the fluid channel 112.

It will be appreciated that the diffraction grating 116 may not cover the entirety of the first surface 114. Accordingly, the optical system 100 can further include a focusing element 120 to loosely focus light onto selected portions of the first surface 114, such that light reflected from the focusing element 120 is directed toward the regions of the first surface containing the diffraction grating 116. By concentrating the light in the regions associated with the diffraction grating 116, the optical power of the high intensity regions produced by the grating can be enhanced. In one example, the focusing element 120 can comprise a spatial light modulator 120 to apply one or both of a phase and an amplitude modulation to the reflected light, as to provide a loosely focused region at the first surface 114. In another example, the focusing element 120 can be implemented as a guided mode diffraction grating.

In one implementation, the focusing element 120 can be used in concert with a spatial light modulator (not shown) that is either bonded to or in close contact with the microfluidic chip assembly 110. In this implementation, the focusing element 120 can be configured to focus reflected light onto portions of the spatial light modulator that are associated with the diffraction grating 116, specifically the portions of the spatial light modulator responsible for applying a phase or amplitude modulation to light incident on the diffraction grating. This implementation allows for high optical power at the fluid channel 112 along with the selective of the various optical traps provided by the spatial light modulator.

FIG. 4 illustrates a flow chart of an example methodology 150 for conveying a particle to a desired location within a microfluidic chip. It is to be understood and appreciated that the illustrated actions, in other implementations, may occur in different orders and/or concurrently with other actions. Moreover, not all illustrated features may be required to implement the methodology.

The methodology 150 begins at 152, where a microfluidic chip and a spatial light modulator are provided. The microfluidic chip can be configured to have a surface comprising a diffraction grating and a fluid channel, and a spatial light modulator can be placed in close proximity to the surface, such that illumination of the surface can be controlled via the spatial light modulator. For example, the spatial light modulator can be controlled electrically to provide one or both of a phase or amplitude modulation configured to produce a desired pattern of attenuation of light incident on the surface of the microfluidic chip.

At 154, selectively illuminating the surface in a first pattern, such that light is provided to a first portion of the surface but not to a second portion of the surface. As with 152, this attenuation can be achieved via electrical control of the spatial light modulator to provide a localized attenuation of light incident on the surface of the microfluidic chip. By selectively illuminating the diffraction grating on the surface, a first optical trap within the fluid channel can be activated without activating other optical traps within the fluid channel. In the illustrated example, selective activation of the first optical trap can be used to direct a given particle to a first location within the fluid channel. For example, the first optical trap can be a line trap that prevents the particle from entering a first region of the fluid channel, forcing the particle into a second region. Alternatively, the second trap can be a point trap that holds the particle at the first location.

At 156, selectively illuminating the surface in a second pattern, such that light is provided to the second portion of the surface but not to the first portion of the surface. By selectively illuminating the diffraction grating on the surface, a second optical trap within the fluid channel can be activated without activating other optical traps within the fluid channel, including the first optical trap. In the illustrated example, selective activation of the second optical trap can be used to direct a given particle from the first location to a second location within the fluid channel.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications, and variations that fall within the scope of the appended claims.

1. A optical system comprising a microfluidic chip assembly, the microfluidic chip assembly comprising:
a first structure providing a first wall of a fluid channel; and
a second structure providing a second wall of the fluid channel and comprising a diffraction grating to provide, in the presence of incident light of a wavelength band of interest on a first surface of the second structure, a region of high intensity light to provide an optical trap within the fluid channel.

2. The optical system of claim 1, wherein the diffraction grating is a guided mode resonance grating.

3. The optical system of claim 1, the first structure comprising a second surface that faces the second structure across the fluid channel, and the second surface being substantially flat and reflective at the wavelength band of interest.

4. The optical system of claim 1, the first structure comprising a second surface that faces the second structure across the fluid channel, and the second surface comprising a diffraction grating (28).

5. The optical system of claim 1, the diffraction grating comprising a first diffraction grating of a plurality of diffraction gratings on the first surface.

6. The optical system of claim 1, wherein the wavelength band of interest is in the near infrared spectrum, and the second structure is fabricated from silicon.

7. The optical system of claim 1, wherein the wavelength band of interest is in the visible spectrum, and the second structure is fabricated from one of gallium phosphide, silicon carbide, and silicon nitride.

8. The optical system of claim 1, further comprising a spatial light modulator configured to selectively permit the incidence of light on the first surface of the second structure and controllable such that at least one of the plurality of regions of high intensity light within the fluid channel can be selectively provided.

9. The optical system of claim 8, the spatial light modulator being bonded to the microfluidic chip.

10. The optical system of claim 8, further comprising a focusing element to reflect light onto the spatial light modulator such that the reflected light is loosely focused at a region of the spatial light modulator associated with the diffraction grating.

11. The optical system of claim 1, further comprising a focusing element to reflect incident light onto the first surface such that the reflected light is loosely focused at a region of the first surface comprising the diffraction grating.

12. The optical system of claim 11, the focusing element comprising a diffraction grating.

13. The optical system of claim 11, the focusing element comprising a spatial light modulator.

14. A method for conveying a particle to a location within a microfluidic chip comprising:
providing a microfluidic chip having a surface comprising at least one diffraction grating and a spatial light modulator proximate thereto, such that illumination of the surface can be controlled via the spatial light modulator;
selectively illuminating the surface with a first pattern, such that light is provided to a first portion of the surface but not to a second portion of the surface, as to activate a first optical trap within a fluid channel of the microfluidic chip to direct a particle to a first location within the fluid channel; and
selectively illuminating the surface with a second pattern, such that light is provided to the second portion of the surface but not to the first portion of the surface, as to activate a second optical trap within a fluid channel of the microfluidic chip to direct a particle to a second location within the fluid channel.

15. The method of claim 14, wherein selectively illuminating the surface in a first pattern comprises modulating an amplitude of a light source at the spatial light modulator.
